(19) United States
(12) Patent Application Publication
(10) Pub. No.: US 2024/0194925 A1
(43) Pub. Date: Jun. 13, 2024

(54) BATTERY ASSEMBLY MACHINE

(71) Applicants: HYUNDAI MOTOR COMPANY, Seoul (KR); KIA CORPORATION, Seoul (KR)

(72) Inventor: Hyun Jun Yoon, Goyang-si (KR)

(21) Appl. No.: 18/197,851

(22) Filed: May 16, 2023

(30) Foreign Application Priority Data
Dec. 13, 2022 (KR) 10-2022-0173229

(51) Int. Cl. H01M 10/04

(52) U.S. Cl. CPC H01M 10/0404

(57) ABSTRACT

A battery assembly machine includes a gripper configured to be movable and to double grip a cell block in which a plurality of cells is stacked, and a pusher configured to provide pressing force for inserting the cell block gripped by the gripper into a case.

### CROSS REFERENCE TO RELATED APPLICATIONS

This application claims, under 35 U.S.C. § 119(a), the benefit of and priority to Korean Patent Application No. 10-2022-0173229, filed on Dec. 13, 2022, the entire contents of which are incorporated herein by reference.

### BACKGROUND

### (a) Technical Field

The present disclosure relates to a battery assembly machine and, more particularly, to a secondary battery assembly machine.

### (b) Background Art

Recently, a secondary battery capable of being recharged has been gradually expanding its application field. Examples of the secondary battery include a small battery used in an electronic device as well as a medium or large battery used in an electric vehicle, an energy storage system, and the like.

Among the examples, the electric vehicle is a vehicle driven by a motor and is provided with a secondary battery as an energy storage configured to drive the motor. Generally, the battery installed in the electric vehicle is assembled in stages in a sequence of a battery cell, a battery module, and a battery pack. The battery is finally mounted in the vehicle as the battery pack.

However, in recent years, in order to secure high energy density, reduce cost, reduce labor, etc., a cell-to-pack (CTP) structure battery in which a plurality of battery cells is blocked and the blocked battery cells are directly assembled into a battery pack, without going through modularization, has appeared.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a battery assembly machine capable of providing a simplified assembly process through automation.

Another object of the present disclosure is to provide a battery assembly machine capable of realizing cost and labor reduction.

The objects of the present disclosure are not limited to the ones mentioned above, and other objects not mentioned herein will be clearly understood by those of ordinary skill in the art to which the present disclosure pertains (hereinafter, “those skilled in the art”) based on the description below.

In one aspect, the present disclosure provides a battery assembly machine including a gripper configured to be movable and to grip a cell block in a plurality of points, and in which a plurality of cells is stacked, and a pusher configured to provide pressing force for inserting the cell block gripped by the gripper into a case.

In another aspect, the present disclosure provides a method of assembling a battery, the method including transporting a cell block gripped by a battery assembly machine to a case, inserting the cell block into the case by a predetermined distance and releasing the grip of a first gripper of the battery assembly machine, inserting the cell block into the case by a predetermined distance and releasing the grip of a second gripper of the battery assembly machine, and providing pressing force to the cell block through a pusher of the battery assembly machine.

Other aspects and preferred embodiments of the disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by both gasoline and electricity.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 illustrates an exemplary battery having a CTP structure;

FIG. 2 is a flowchart of assembly of a battery according to an embodiment of the present disclosure;

FIG. 3 illustrates an assembly process of a battery according to an embodiment of the present disclosure;

FIGS. 4A, 4B, 4C, and 4D schematically illustrate the operation process of a battery assembly machine according to an embodiment of the present disclosure;

FIG. 5 is a front view of a battery assembly machine according to an embodiment of the present disclosure;

FIG. 6 is a plan view of a battery assembly machine according to an embodiment of the present disclosure;

FIG. 7 illustrates the operation of a battery assembly machine according to an embodiment of the present disclosure;

FIG. 8 is a block diagram of a battery assembly machine according to an embodiment of the present disclosure; and

FIGS. 9, 10, 11, and 12 illustrate the operation process of a battery assembly machine according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and usage environment.

In the figures, reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” another component, the component may be directly connected to the other component, or intervening components may also be present. In contrast, when a component is referred to as being “directly connected to” another component, there is no intervening component present. Other terms used to describe relationships between components should be interpreted in a like fashion (e.g., “between” versus “directly between”, “adjacent” versus “directly adjacent”, etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure will be described in detail with reference to the accompanying drawings.

As described above, a cell-to-pack (CTP) structure battery is directly assembled into a battery pack without going through modularization of battery cells during an assembly process.

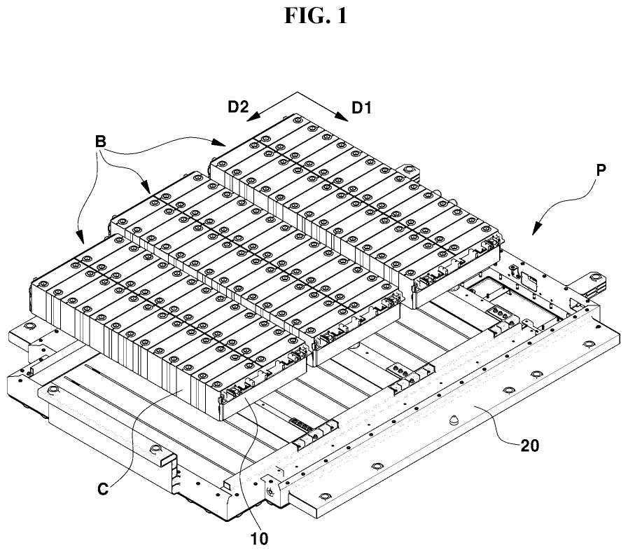

As illustrated in FIG. 1, the CTP structure battery includes a cell block B in which a plurality of prismatic cells C is stacked. Specifically, the cell block B has a plurality of cells C stacked in a longitudinal direction D1 and has at least two cells C connected to each other in a horizontal direction D2. The cells C in the cell block B may have attached therebetween an absorption pad for swelling absorption or an insulation pad for insulation between the cells. The cell block B may be prepared in such a manner that the end portions of the cell block B in the longitudinal direction D1 each have mounted thereto an end plate 10 configured to cover the end portion.

The prepared cell block B is inserted into a case 20 and assembled into a battery pack P. When a predetermined number of cell blocks B is disposed in the case 20, an upper housing is assembled to the case 20 to protect the cell blocks B.

In a state in which the cell block B is blocked without an additional support, the cell block B must be press-fitted into the case 20 so that the surface pressure between the cells C may be kept constant. However, there is a difficulty in assembling the CTP structure battery because sufficient assembly tolerance is not secured between the case 20 and the cell block B.

For this reason, the present disclosure provides an automated battery assembly machine capable of directly mounting a blocked cell block B in a case 20 without additional support.

Particularly, the present disclosure provides an automated battery assembly machine capable of pressurizing the cell block B through a series of steps and press-fitting the pressurized cell block B into the case 20. Therefore, the battery assembly machine according to the present disclosure may improve the productivity of the battery and may also provide an effect of cost reduction due to the omission of components, such as a support.

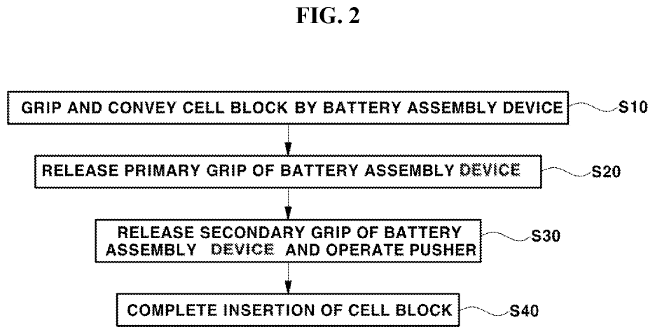

Referring to FIG. 2, a battery assembly machine 100 according to the present disclosure may perform a series of steps. The battery assembly machine 100 may grip and convey the cell block B, and insert the same into the case 20 through a series of steps.

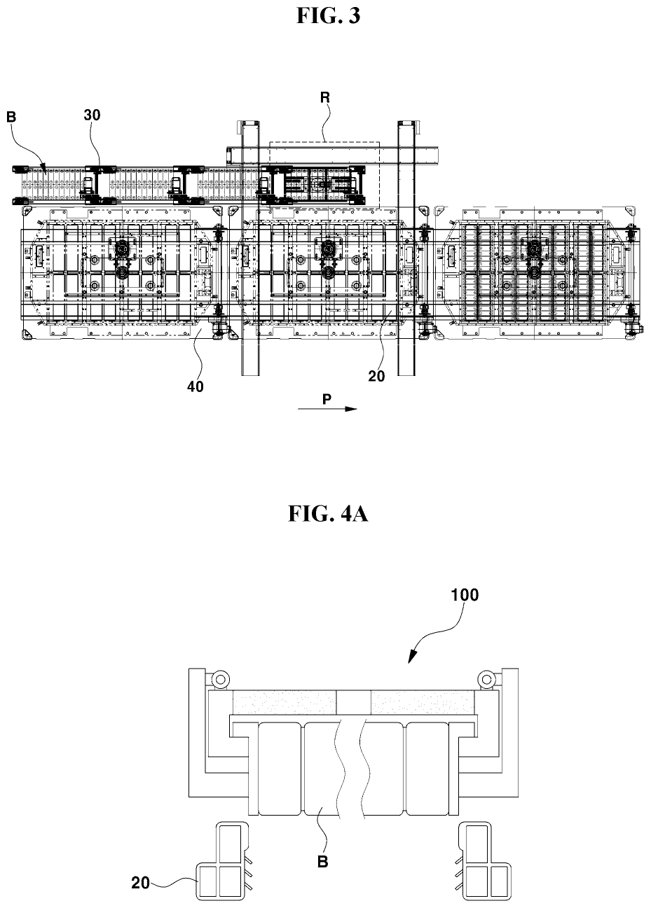

Referring additionally to FIG. 3, the cell block B to be assembled into the case 20 and the case 20 are continuously supplied in a processing direction P using a cell block conveyor 30 and a case conveyor 40, respectively. The cell block conveyor 30, the case conveyor 40, and the battery assembly machine 100 are operatively associated with one another.

Specifically, the cell block B to be assembled may be continuously supplied to an insertion site R in the processing direction P using the cell block conveyor 30. The battery assembly machine 100 is disposed at the insertion site R. In addition, the case 20 into which the cell block B is to be assembled may be supplied using the case conveyor 40 disposed adjacent to the cell block conveyor 30.

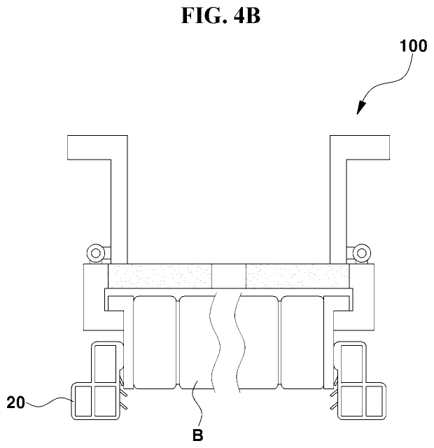

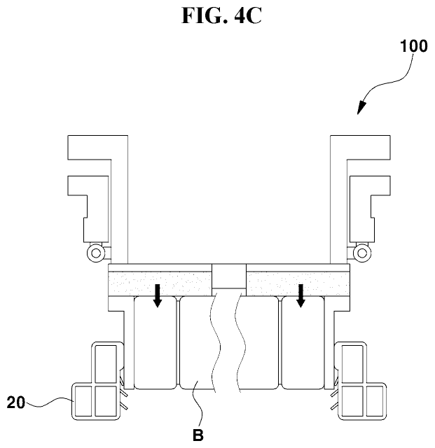

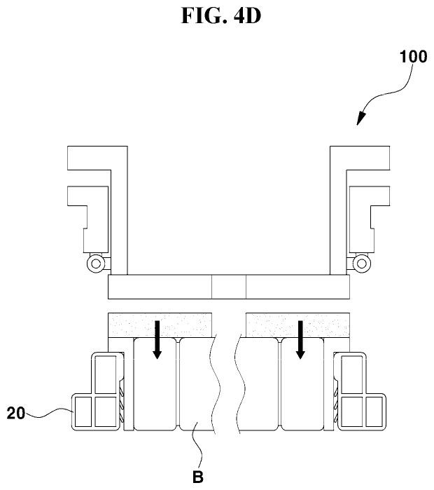

Referring additionally to FIGS. 4A to 4C, the battery assembly machine 100 may grip the cell block B disposed at the insertion site R and convey the cell block B to the case 20 disposed on the case conveyor 40 at S10. Here, the cell block B is double gripped by the battery assembly machine 100. The battery assembly machine 100 moves to a preset position of the case 20 and aligns the cell block B above the case 20 (see FIG. 4A). Next, the battery assembly machine 100 primarily releases the grip on the cell block B and inserts the cell block B in a pressurized state into the case 20 at S20 (see FIG. 4B). Thereafter, the battery assembly machine 100 secondarily releases the grip on the cell block B and pushes the cell block B into the case 20 at S30 (see FIG. 4C). Then insertion of the cell block B may be completed at S40 (see FIG. 4D).

Hereinafter, the battery assembly machine 100 according to an embodiment of the present disclosure capable of performing the series of steps will be described.

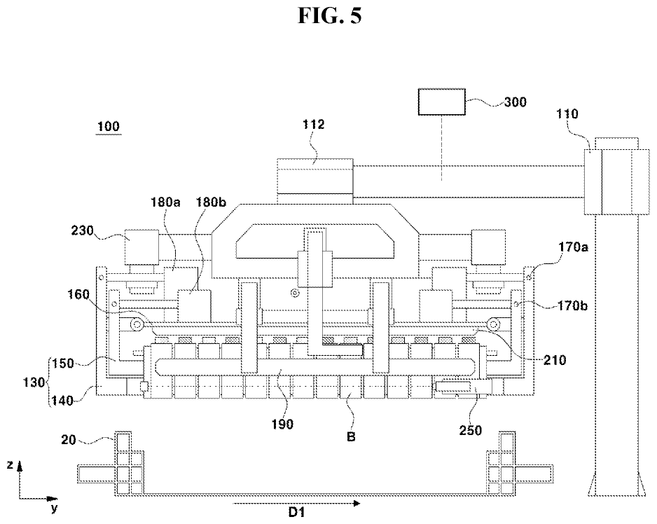

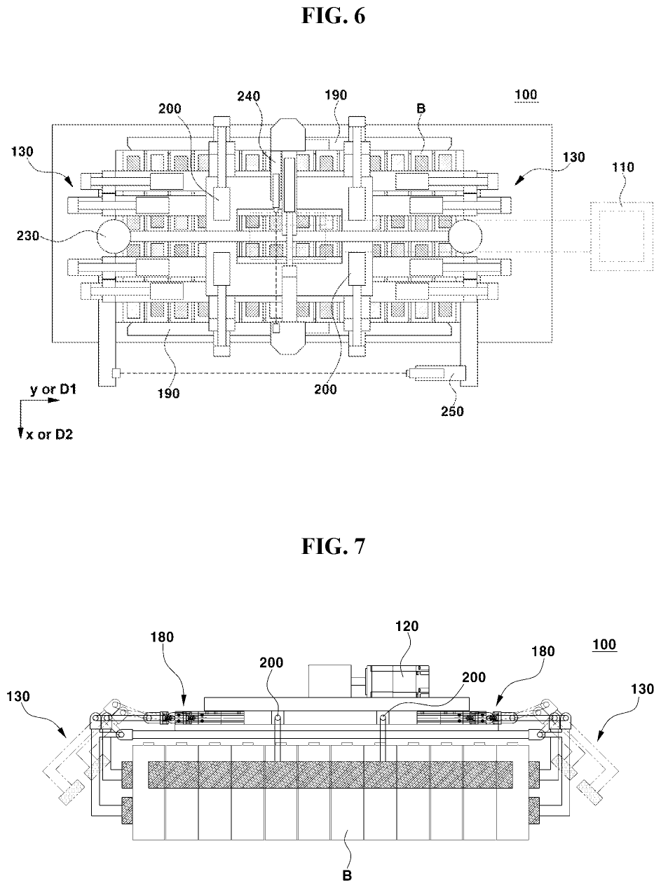

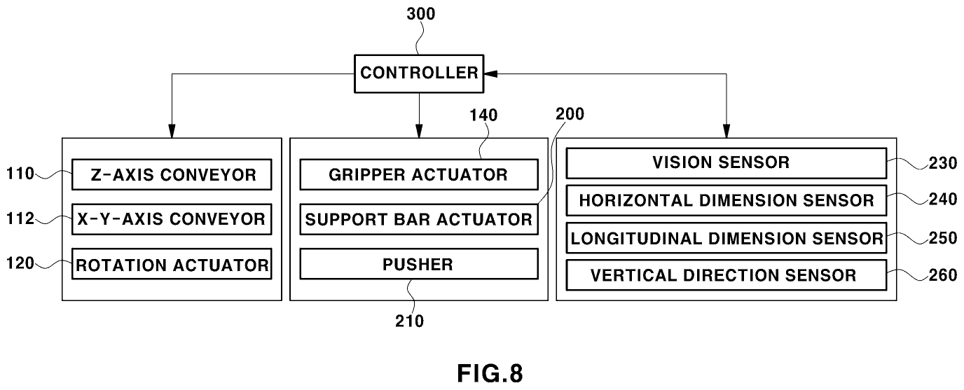

As illustrated in FIGS. 5 to 7, the battery assembly machine 100 may be movable. The battery assembly machine 100 may move in a vertical direction. In one embodiment, the battery assembly machine 100 may include a z-axis conveyor 110 and may move in the vertical direction (z-axis direction). In addition, the battery assembly machine 100 may move in an x-y plane (x-axis direction and y-axis direction). In one embodiment, the battery assembly machine 100 may include an x-y-axis conveyor 112 and may move in the x-y plane. Also, the battery assembly machine 100 may include a rotating actuator 120. The rotating actuator 120 may rotatably operate the battery assembly machine 100.

The battery assembly machine 100 includes a gripper 130. The gripper 130 may provide pressing force to the cell block B in the longitudinal direction (y-axis direction). Particularly, the gripper 130 may grip each end portion of the cell block B in the longitudinal direction or each lateral surface parallel to the horizontal direction D2 of the cell block B. Here, the gripper 130 may grip the lateral surface of the cell block B using the end plate 10.

The shape of the gripper 130 is not significantly limited. However, the gripper 130 may extend along the lateral surface of the cell block B. In order for the pressing force of the gripper 130 to be evenly distributed on the lateral surface of the cell block B, the gripper 130 may have a shape extending in the horizontal direction D2. In an embodiment, a portion of the gripper 130 in direct contact with the cell block B may be made of silicone or urethane instead of rubber. The gripper 130 is made of such a material to prevent damage that may be applied to the end plate 10 or to the cell C. Instead, the gripper 130 may also be made of a rigid but insulating material.

The gripper 130 includes at least two grippers 130. The two grippers 130 each may grip different portions at the end portion of the cell block B in the longitudinal direction D1. The battery assembly machine 100 includes at least two grippers 130 configured to operate at different times to avoid interference when the cell block B is inserted into the case 20. In the illustrated embodiment, a first gripper 140 of the two grippers 130 may grip the lower side of the end portion of the cell block B in the longitudinal direction D1. On the other hand, a second gripper 150 of the two grippers 130 may grip the upper side of the end portion of the cell block B in the longitudinal direction D1.

The gripper 130 is coupled to a frame 160 to grip or release the cell block B. To this end, the gripper 130 may be rotatable about pivot points 170a, 170b. The first gripper 140 is coupled to the frame 160 to rotate about a first pivot point 170a, and the second gripper 150 is coupled to the frame 160 to rotate about a second pivot point 170b. The first gripper 140 and the second gripper 150 may rotate by an actuator 180 (180a, 180b). According to an embodiment of the present disclosure, the actuator 180 may be a servomotor. However, the actuator 180 is not limited to a servomotor, and another type of actuator may be used.

The battery assembly machine 100 includes a support bar 190. The support bar 190 may be coupled to the frame 160 to support the longitudinal surface of the cell block B parallel to the longitudinal direction D1 of the cell block B. When the cell block B is conveyed or inserted into the case 20, the support bar 190 may maintain the alignment of the cells C in the cell block B.

In an embodiment, the support bar 190 is rotatably coupled to the frame 160. When the support bar 190 supports the longitudinal surface of the cell block B, the support bar 190 may rotate from the frame 160 to contact with the longitudinal surface of the cell block B. In an embodiment, the support bar 190 is slidably coupled to the frame 160. The support bar 190 slides from the frame 160 and contacts with the longitudinal surface of the cell block B, thereby supporting the cell block B.

The support bar 190 may be operated by an actuator 200 configured to actuate the support bar 190. The actuator 200 for the support bar 190 may be a servomotor. However, the actuator 200 is not limited to a servomotor and, another type of actuator may be used.

In an embodiment, a portion of the support bar 190 brought into contact with the cell block B may be made of silicone or urethane instead of rubber. The support bar 190 made of such a material may prevent damage that may be applied to the cell block B due to contact. Instead, the support bar 190 may also be made of a rigid but insulating material.

The battery assembly machine 100 includes a pusher 210. The pusher 210 may be coupled to the frame 160 and may provide pressing force to the cell block B. The pusher 210 may assist the cell block B to be inserted into the case 20 by applying pressing force to the upper surface of the cell block B. The pusher 210 may be operable by a pusher actuator. The pusher actuator may be a servomotor, but is not limited thereto, and an actuator using pneumatic or hydraulic pressure may be used.

The battery assembly machine 100 may include a plurality of sensors 230, 240, 250, 260. The sensors 230, 240, 250, 260 enable the battery assembly machine 100 to insert the cell block B into the case 20 at an accurate position and time.

According to an embodiment of the present disclosure, the battery assembly machine 100 includes a vision sensor 230. The vision sensor 230 may detect whether the cell block B is placed at a proper position for insertion when the cell block B is conveyed to a position right above the case 20. The controller 300 may adjust the position of the battery assembly machine 100 according to the detection result of the vision sensor 230.

The battery assembly machine 100 may include a horizontal dimension sensor 240. The horizontal dimension sensor 240 may measure the dimension of the cell block B in the horizontal direction D2. The value measured by the horizontal dimension sensor 240 is the basis for determining whether the cells C positioned in the horizontal direction D2 are correctly aligned.

According to an embodiment of the present disclosure, the battery assembly machine 100 may include a longitudinal dimension sensor 250. The longitudinal dimension sensor 250 may measure the longitudinal dimension of the cell block B. The value measured by the longitudinal dimension sensor 250 may be the basis for determining whether a predetermined number of cells C is stacked in the longitudinal direction D1 in the cell block B and whether the cell block B maintains the pressing force for being press-fitted into the case 20.

According to an embodiment of the present disclosure, the battery assembly machine 100 may include a vertical direction sensor 260. The vertical direction sensor 260 provides a basis for determining whether the cell block B is accurately press-fitted. As a non-limiting example, the vertical direction sensor 260 may measure a vertical (z-axis direction) movement distance of the battery assembly machine 100. The vertical movement distance may be calculated by summing the movement amount of the z-axis conveyor 110 and the movement amount of the pusher 210. As another non-limiting example, the vertical direction sensor 260 may be a touch sensor. The vertical direction sensor 260 is installed on the inner surface of the case 20. When the cell block B is in contact with the vertical direction sensor 260, the vertical direction sensor 260 may determine that the cell block B is correctly seated in the case 20.

The battery assembly machine 100 may further include a controller 300. The controller 300 may control the operation of the battery assembly machine 100. For example, the controller 300 may supervise the operations of the z-axis conveyor 110, the x-y-axis conveyor 112, and the rotating actuator 120. In addition, the controller 300 may control the operations of the actuators 140, 200 and the pusher 210. The controller 300 may receive the measured values from the sensors 230, 240, 250, 260. When there is an abnormality based on the measured values of the sensors 230, 240, 250, 260, the controller 300 may correct the operation of the battery assembly machine 100.

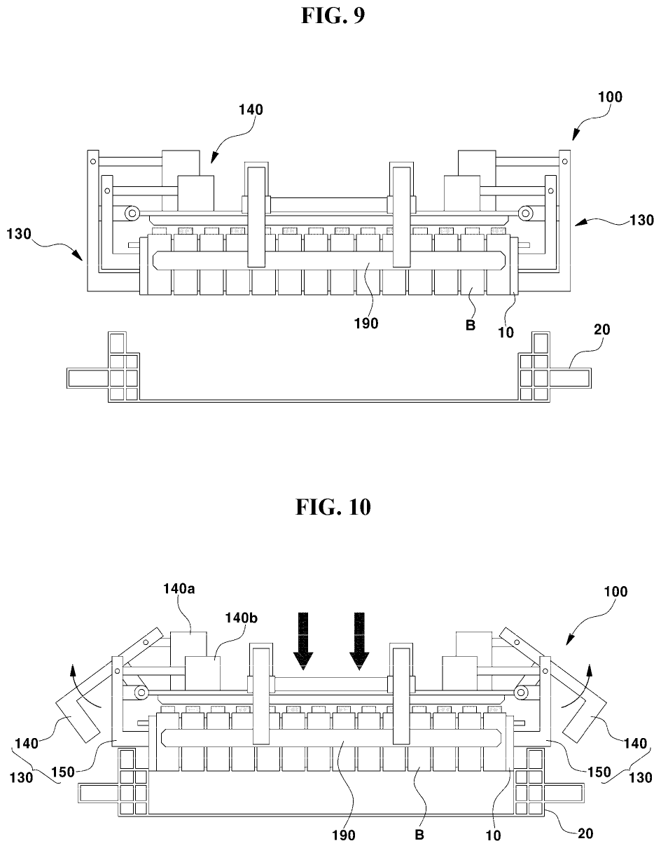

Hereinafter, the operation of the battery assembly machine 100 according to the present disclosure will be described with reference to FIGS. 9 to 12.

First, the cell block B located at the insertion site R is gripped by the battery assembly machine 100. The cell block B gripped through the operation of the x-y-axis conveyor 112 and the z-axis conveyor 110 of the battery assembly machine 100 is conveyed to the case 20 placed on the case conveyor 40, as in FIG. 9.

The end portions of the cell block B in the longitudinal direction are gripped by the grippers 130, and the support bar 190 holds the longitudinal surface of the cell block B. Here, the vision sensor 230 detects whether the cell block B being gripped by the battery assembly machine 100 is aligned with the inside of the case 20, into which the cell block B is to be press-fitted. The detection information of the vision sensor 230 is transmitted to the controller 300. Based on the transmitted detection information, the controller 300, when there is an abnormality, controls the battery assembly machine 100 so that the cell block B is aligned with the inside of the case 20 through the operation of the x-y-axis conveyor 112 of the battery assembly machine 100.

When the vision sensor 230 determines that the cell block B is aligned with the case 20 at the insertion position, the controller 300 lowers the cell block B by operating the z-axis conveyor 110, as in FIG. 10. The controller 300 stops lowering the z-axis conveyor 110 at a predetermined time point. Thereafter, the controller 300 operates an actuator 180a of the first gripper 140 so that the first gripper 140 releases the grip. The predetermined time point may be determined by the degree of insertion of the cell block B, the degree of proximity between the first gripper 140 and the case 20, and the like. As a non-limiting example, a proximity sensor may be used as a sensor to detect such factors.

Here, the longitudinal dimension sensor 250 may detect the longitudinal D1 length of the cell block B. Dimension information detected by the longitudinal dimension sensor 250 is transmitted to the controller 300. The controller 300 compares a preset longitudinal dimension with the transmitted detected dimension information to determine whether the pressure on the cell block B is properly maintained. When the detected dimensional information does not satisfy the preset longitudinal dimensional range, the controller 300 may inform a worker to take necessary measures.

When the detected dimension information satisfies the preset longitudinal dimension range, the controller 300 operates the z-axis conveyor 110 to lower the cell block B further into the case 20.

As in FIG. 11, at a predetermined position, the controller 300 stops lowering the z-axis conveyor 110, and operates an actuator 180b of the second gripper 150 to release the grip of the second gripper 150. Then the controller 300 completely pushes the cell block B into the case 20 while further lowering the cell block B using the z-axis conveyor 110. Here, the controller 300 operates the pusher 210 to provide force needed in press-fitting the cell block B into the case 20. When the vertical direction sensor 260 detects that the cell block B is accurately seated, press-fitting of the cell block B is completed.

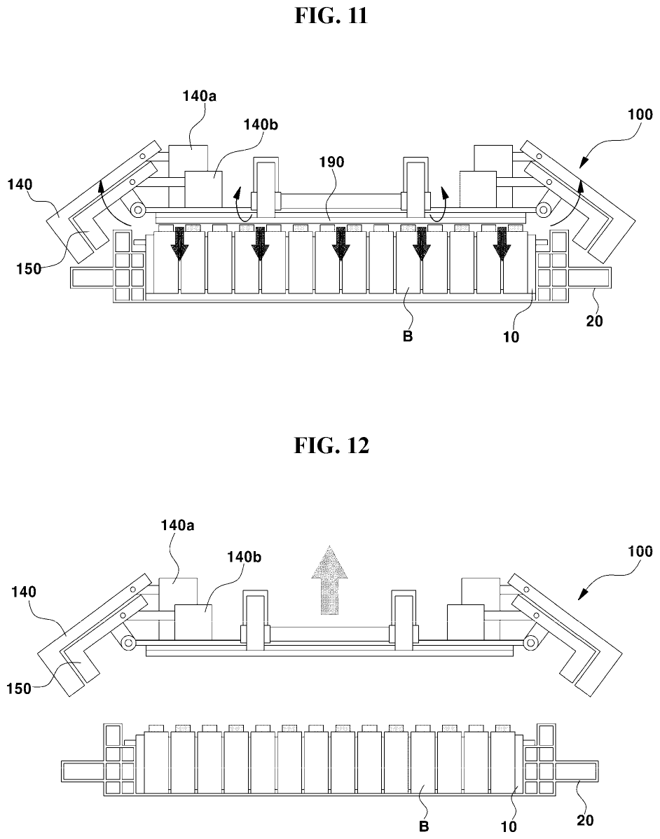

As illustrated in FIG. 12, the battery assembly machine 100 may return to the insertion site R by the operations of the z-axis conveyor 110 and the x-y-axis conveyor 112.

As such, the battery assembly machine according to the present disclosure may automatically assemble the cell block into the case, thereby simplifying the assembly process and improving the quality of the battery pack.

As is apparent from the above description, the present disclosure provides the following effects.

According to the present disclosure, a battery assembly machine capable of providing a simplified assembly process through automation is provided.

According to the present disclosure, a battery assembly machine capable of realizing cost and labor reduction is proposed.

Effects of the present disclosure are not limited to the ones described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

1. A battery assembly machine comprising:
a gripper configured to be movable and to grip a cell block at a plurality of points, wherein a plurality of cells is stacked on the cell block; and
a pusher configured to provide a pressing force for inserting each of the plurality of cells into a case.

2. The battery assembly machine according to claim 1, wherein the gripper comprises:
a first gripper configured to grip a first portion of a lateral surface of the cell block; and
a second gripper configured to grip a second portion of the lateral surface of the cell block.

3. The battery assembly machine according to claim 2, wherein the first gripper is rotatable about a first pivot point, and the second gripper is rotatable about a second pivot point.

4. The battery assembly machine according to claim 2, wherein the first gripper and the second gripper each extend along the lateral surface of the cell block.

5. The battery assembly machine according to claim 1, wherein the gripper is movable in a vertical direction and in a planar direction which is perpendicular to the vertical direction, to move the cell block towards the case.

6. The battery assembly machine according to claim 1, further comprising a support bar configured to support the gripped cell block.

7. The battery assembly machine according to claim 6, wherein the support bar contacts a longitudinal surface of the cell block, wherein the plurality of cells are stacked in a longitudinal direction in the cell block.

8. The battery assembly machine according to claim 1, further comprising a plurality of sensors configured to detect a position between the cell block and the case.

9. The battery assembly machine according to claim 8, wherein the plurality of sensors comprise a vision sensor configured to detect whether the cell block is aligned with the case before being inserted into the case.

10. The battery assembly machine according to claim 8, wherein the plurality of sensors comprise a longitudinal dimension sensor configured to measure a longitudinal dimension of the cell block.

11. The battery assembly machine according to claim 8, wherein the plurality of sensors comprise a horizontal dimension sensor configured to measure a horizontal dimension of the cell block.

12. The battery assembly machine according to claim 8, wherein the plurality of sensors comprise a vertical direction sensor configured to detect whether the cell block is inserted into the case.

13. The battery assembly machine according to claim 8, further comprising a controller configured to correct a position of the gripped cell block with respect to the case based on information detected by the plurality of sensors.

14. A method of assembling a battery, the method comprising:
gripping a cell block by a first gripper and a second gripper of a battery assembly machine;
transporting the cell block to a case;
inserting the cell block into the case a first predetermined distance, and releasing a grip of the first gripper;
after releasing the grip of the first gripper, inserting the cell block into the case by a second predetermined distance and releasing a grip of the second gripper; and
providing pressing force to the cell block through a pusher of the battery assembly machine.

15. The method according to claim 14, wherein the cell block is supplied from a cell block conveyor and the case is supplied from a case conveyor disposed adjacent to the cell block conveyor.

16. The method according to claim 14, further comprising:
obtaining, by a controller, detection information detected by a plurality of sensors provided in the battery assembly machine; and
controlling a location of the battery assembly machine based on the detection information.

17. The method according to claim 16, further comprising:
after conveying the cell block to the case, lowering the cell block towards the case by the battery assembly machine;
detecting a position between the cell block and the case by a vision sensor among the plurality of sensors; and
determining, by the controller, alignment between the case and the cell block being gripped based on the detection of the vision sensor.

18. The method according to claim 16, further comprising:
measuring a horizontal length of the cell block by a horizontal dimension sensor among the plurality of sensors; and
determining, by the controller, whether cells in the cell block are aligned in the horizontal direction based on the measured horizontal length.

19. The method according to claim 16, further comprising:
measuring a longitudinal length of the cell block by a longitudinal dimension sensor among the plurality of sensors; and
determining, by the controller, whether cells in the cell block are aligned in a longitudinal direction based on the measured longitudinal length.

20. The method according to claim 16, further comprising:
after applying the pressing force by the pusher, measuring a vertical moving distance of the cell block by a vertical direction sensor among the plurality of sensors; and
determining, by the controller, whether the cell block is inserted into the case based on the detection of the vertical direction sensor.
